(19) United States
(12) Patent Application Publication
(10) Pub. No.: US 2026/0168430 A1
(43) Pub. Date: Jun. 18, 2026

(54) MOTOR UNIT

(71) Applicant: TOYOTA JIDOSHA KABUSHIKI KAISHA, Toyota-shi (JP)

(72) Inventors: Kota FUJII, Nisshin-shi (JP); Masayuki ISHIBASHI, Numazu-shi (JP); Yukinobu NISHIKAWA, Anjyou-shi (JP)

(73) Assignee: TOYOTA JIDOSHA KABUSHIKI KAISHA, Toyota-shi (JP)

(21) Appl. No.: 19/379,820

(22) Filed: Nov. 5, 2025

(30) Foreign Application Priority Data
Dec. 17, 2024 (JP) 2024-220960

(51) Int. Cl. F01P 11/08; B60K 11/02; F01P 5/10

(52) U.S. Cl. CPC F01P 11/08; B60K 11/02; F01P 5/10

(57) ABSTRACT

A motor unit may include a case and an oil supply device that supplies oil to the motor and gear chambers within the case. The oil supply device may include an oil pump; an oil cooler; a first oil passage, wherein the first oil passage may be configured such that the oil supplied from the oil pump flows through the first oil passage when a first valve is open, and connect the oil pump, an oil supply port of the gear chamber, and a first end of an inner passage of the oil cooler; and a second passage, wherein the second passage may be configured such that the oil supplied from the oil pump flows through the second oil passage when a second valve is open, and connect the oil pump, an oil supply port of the motor chamber, and a second end of the inner passage.

### CROSS REFERENCE TO RELATED APPLICATION

This application claims priority to Japanese Patent Application No. 2024-220960 filed on December 17, 2024. The entire content of the priority application is incorporated herein by reference.

### TECHNICAL FIELD

The art disclosed herein relates to a motor unit.

### BACKGROUND ART

In a motor unit described in Japanese Patent Application Publication No. 2024-131256, a case includes a motor chamber and a gear chamber. A motor is positioned in the motor chamber, and a gear is positioned in the gear chamber. Further, this motor unit includes an oil cooler for cooling oil. The oil cooled by the oil cooler is supplied into the case. Thereby, the motor unit is cooled.

### SUMMARY

Oil has high viscosity when its temperature is low. Supplying oil cooled by an oil cooler to a motor chamber when the temperature of a motor is low may cause a decrease in the motor efficiency. The disclosure herein proposes a technology that allows for a supply of oil that is not cooled by an oil cooler to a motor chamber in a motor unit as well as a reduction in the size of the motor unit.

A motor unit disclosed herein may comprise a case comprising a motor chamber and a gear chamber; a motor positioned in the motor chamber; a gear positioned in the gear chamber and engaged with a rotation shaft of the motor; and an oil supply device configured to supply oil to the motor chamber and the gear chamber. The oil supply device may comprise an oil pump, an oil cooler, a first oil passage, and a second passage. The first oil passage may comprise a first valve, be configured such that the oil supplied from the oil pump flows through the first oil passage when the first valve is open, and connect the oil pump, an oil supply port of the gear chamber, and a first end of an inner passage of the oil cooler. The second passage may comprise a second valve, be configured such that the oil supplied from the oil pump flows through the second oil passage when the second valve is open, and connect the oil pump, an oil supply port of the motor chamber, and a second end of the inner passage.

This motor unit is configured to selectively operate in a first operation mode where the first valve is open or in a second operation mode where the second valve is open. In the first operation mode, the oil is supplied to the gear chamber and the oil cooler through the first oil passage. After flowing through the oil cooler (i.e., the inner passage) from the first end to the second end, the oil is supplied to the motor chamber through the second oil passage. As described, in the first operation mode, the oil is supplied to both the motor chamber and the gear chamber. In this case, low-temperature oil, which has flowed through the oil cooler, is supplied to the motor chamber. In the second operation mode, the oil is supplied to the motor chamber and the oil cooler through the second oil passage. After flowing through the oil cooler (i.e., the inner passage) from the second end to the first end, the oil is supplied to the gear chamber through the first oil passage. Thus, in the second operation mode, the oil is also supplied to both the motor chamber and the gear chamber. In this case, relatively high-temperature oil, which has not flowed through the oil cooler, is supplied to the motor chamber. The configuration above allows for switching between the first operation mode where the oil that has flowed through the oil cooler is supplied to the motor chamber and the second operation mode where the oil that has not flowed through the oil cooler is supplied to the motor chamber. Further, the configuration above does not require a flow passage to bypass the oil cooler since the oil flows through the oil cooler in one direction in the first operation mode and in the opposite direction in the second operation mode. This allows for a reduction in the size of the motor unit.

### BRIEF DESCRIPTION OF DRAWINGS

FIG. 1 is a side view of a vehicle.

FIG. 2 is a perspective view of a motor unit 16.

FIG. 3 is a cross-sectional view illustrating an internal structure of a case 20.

FIG. 4 is a diagram illustrating passages of an oil supply device 70.

FIG. 5 is a diagram illustrating a bypass passage 100 of an oil supply device 70 according to a comparative example.

### DETAILED DESCRIPTION

In one aspect of the present teachings, cooling performance of the oil cooler may be higher when the oil flows through the inner passage from the first end to the second end than when the oil flows through the inner passage from the second end to the first end.

This configuration allows for a supply of low-viscosity oil to the gear chamber in the second operation mode.

In one aspect of the present teachings, the motor unit may be mounted on a vehicle. The oil supply port of the motor chamber and the oil supply port of the gear chamber may be spaced from each other in a vehicle width direction. The oil cooler may comprise an elongated shape in the vehicle width direction. The first end and the second end may be located between the oil supply port of the motor chamber and the oil supply port of the gear chamber in the vehicle width direction such that the first end is positioned closer to the oil supply port of the gear chamber than the second end is in the vehicle width direction.

This configuration allows for a reduction in the length of a flow passage between the motor chamber and the second end and the length of a flow passage between the gear chamber and the first end.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved motor units, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

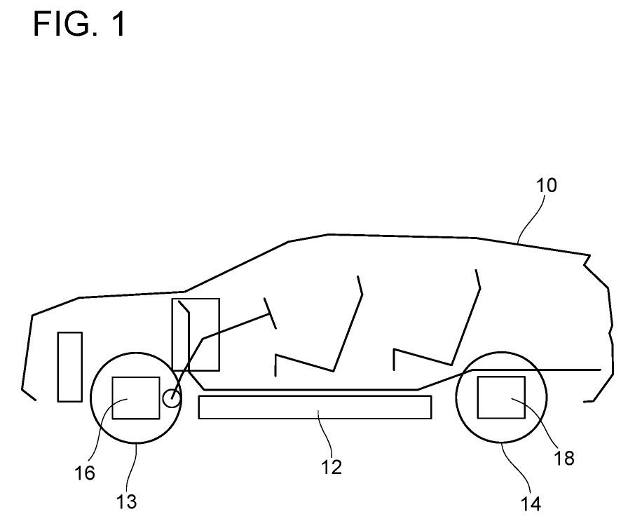

A vehicle 10 illustrated in FIG. 1 comprises an electric motor as at least one drive source. The vehicle 10 may be, for example, an electric vehicle, a hybrid vehicle, or a fuel-cell vehicle.

The vehicle 10 comprises a battery pack 12 located below the floor and two motor units 16, 18. The battery pack 12 supplies current power to each of the motor units 16, 18. The motor unit 16 drives front wheels 13, and the motor unit 18 drives rear wheels 14. Although the vehicle 10 is illustrated as a four-wheel-drive vehicle, the vehicle 10 may be a two-wheel-drive vehicle comprising only one of the motor units 16, 18. The motor units 16, 18 have a common structure. Hereinafter, the motor unit 16 is described.

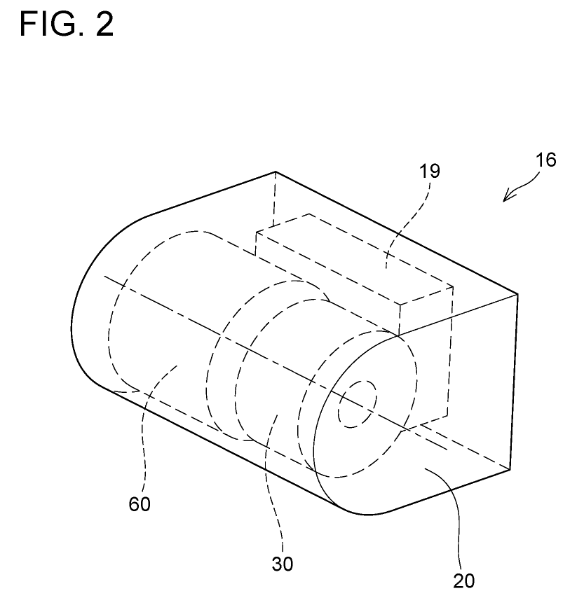

As illustrated in FIG. 2, the motor unit 16 comprises a case 20, a motor 60, a gear mechanism 30, and a power control unit 19. The motor 60, the gear mechanism 30, and the power control unit 19 are housed in the case 20. The power control unit 19 is positioned adjacent to the motor 60 and the gear mechanism 30 in a front-rear direction of the vehicle (positioned rearward of the motor 60 and the gear mechanism 30 in this example). The power control unit 19 converts DC power from the battery pack 12 to AC power and supplies it to the motor 60. The motor 60 generates a driving force based on the AC power supplied from the power control unit 19. The gear mechanism 30 amplifies the torque of the driving force generated by the motor 60 and then distributes it to the right and left wheels.

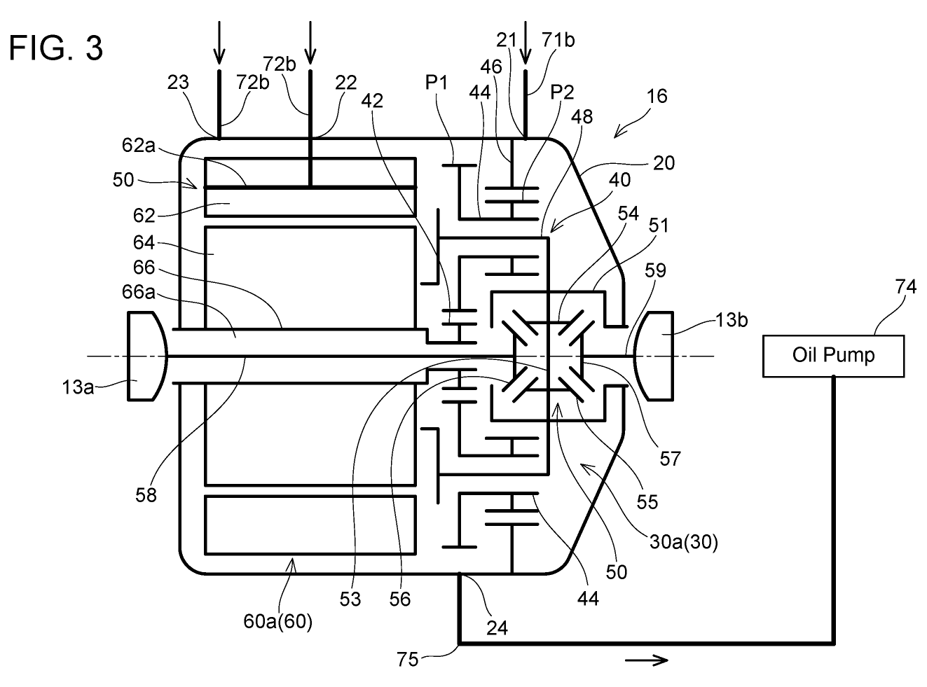

As illustrated in FIG. 3, the case 20 comprises a motor chamber 60a in which the motor 60 is housed and a gear chamber 30a in which the gear mechanism 30 is housed. The motor chamber 60a and the gear chamber 30a are in communication with each other.

The motor 60 comprises a stator 62 and a rotor 64. The stator 62 is fixed to the case 20. The rotor 64 is concentric with the stator 62 and positioned inward of the stator 62. The rotor 64 is supported by the case 20 such that the rotor 64 is freely rotatable about its center axis. An output shaft 66 of the rotor 64 is hollow. That is, the output shaft 66 defines a through hole 66a extending along its center axis.

The gear mechanism 30 comprises a planetary gear mechanism 40 and a differential gear 50. Each of the planetary gear mechanism 40 and the differential gear 50 comprises a plurality of gears. The planetary gear mechanism 40 reduces the rotational speed of the output shaft 66 of the motor 60. The differential gear 50 distributes the driving force from the motor 60 transmitted via the planetary gear mechanism 40 to left and right front wheels 13a, 13b. The motor 60, the planetary gear mechanism 40, and the differential gear 50 are coaxial with each other. It is to be understood that the configuration of the gear mechanism 30 described below is merely an example, and any other configuration can be adopted if applicable.

The planetary gear mechanism 40 comprises a sun gear 42, a plurality of stepped pinion gears 44, a ring gear 46, and a carrier 48. The sun gear 42 is connected to the output shaft 66 of the motor 60 and rotates integrally with the output shaft 66. The plurality of stepped pinion gears 44 includes a large-diameter pinion gear P1 and a small-diameter pinion gear P2 having a smaller diameter than the large-diameter pinion gear P1. The large-diameter pinon gear P1 is meshed with the sun gear 42. The small-diameter pinion gear P2 is meshed with the ring gear 46. The ring gear 46 is fixed to the case 20. The carrier 48 supports the plurality of stepped pinion gears 44 such that each gear 44 is freely rotatable. Thus, in the planetary gear mechanism 40, the sun gear 42 is an input element, the ring gear 46 is a reaction element, and the carrier 48 is an output element.

The differential gear 50 comprises a differential case 51. The differential case 51 is supported by the case 20 such that the differential case 51 is freely rotatable about the rotation axis of the motor 60. The differential case 51 is connected to the carrier 48 of the planetary gear mechanism 40 and rotates integrally with the carrier 48.

A pinion shaft 53, a pair of differential pinion gears 54, 55, and side gears 56, 57 are located in the differential case 51.

The pinion shaft 53 is connected to the differential case 51 and rotates integrally with the differential case 51. The pinion shaft 53 extends within the differential case 51 in a direction perpendicular to the direction of the rotation axis of the motor 60. The differential pinion gears 54, 55 are each supported by the pinion shaft 53 such that they are freely rotatable about the axis of the pinion shaft 53. The side gear 56 is a member configured to output the driving force to the front wheel 13a and is meshed with each of the differential pinion gears 54, 55. The side gear 57 is a member configured to output the driving force to the front wheel 13b and is meshed with each of the differential pinion gears 54, 55.

The motor unit 16 further comprises drive shafts 58, 59. The drive shaft 58 is inserted in the through hole 66a of the output shaft 66. The drive shaft 58 connects the side gear 56 to the front wheel 13a. The drive shaft 59 connects the side gear 57 to the front wheel 13b. The drive shafts 58, 59 transmit the driving force from the differential gear 50 to the left and right front wheels 13a, 13b.

Lubricant oil is stored in a bottom portion of the case 20. The case 20 includes an oil discharge port 24, motor chamber oil supply ports 22, 23, and a gear chamber oil supply port 21. The oil discharge port 24 is defined in the bottom portion of the case 20. The oil stored in the case 20 is discharged through the oil discharge port 24 to the outside of the case 20. The oil is supplied from the outside through the motor chamber oil supply ports 22, 23 and the gear chamber oil supply port 21. The motor chamber oil supply ports 22, 23 are defined in an upper portion of the motor chamber 60a. The oil supplied from the outside is ejected through the motor chamber oil supply port 22 toward the stator 62. The motor chamber oil supply port 23 is connected to a cooling passage 62a defined inside the stator 62. The oil supplied from the outside through the motor chamber oil supply port 23 flows into the cooling passage 62a. After flowing through the cooling passage 62a, the oil is discharged into the motor chamber 60a. The gear chamber oil supply port 21 is defined in an upper portion of the gear chamber 30a. The oil supplied from the outside is ejected through the gear chamber oil supply port 21 toward the gears.

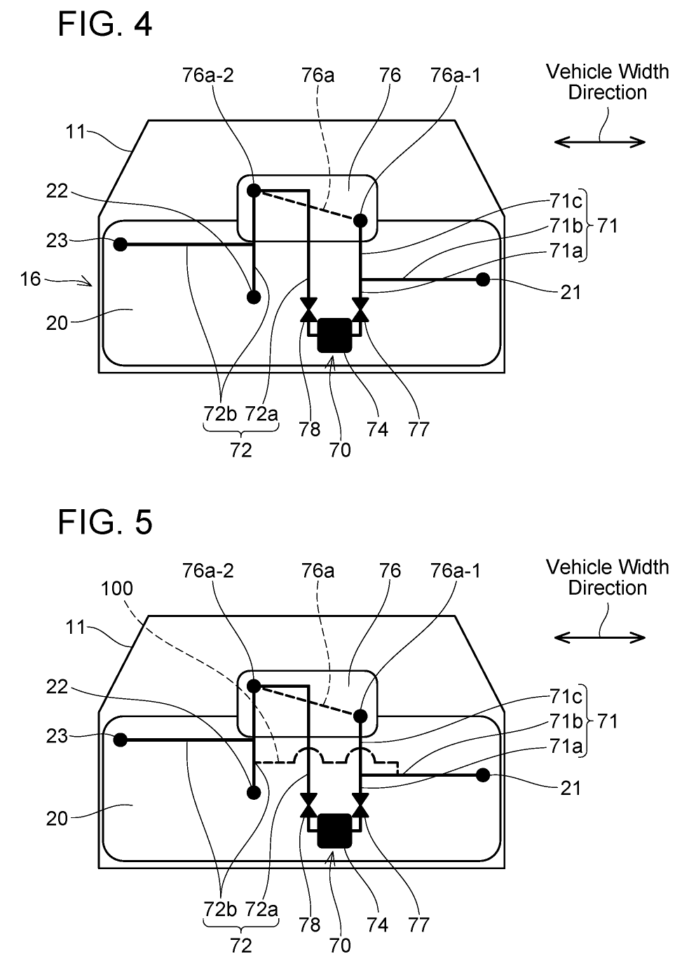

FIG. 4 is a top view of a front compartment 11 of the vehicle 10. As illustrated in FIG. 4, the case 20 is located in the front compartment 11. The motor unit 16 further comprises an oil supply device 70. The oil supply device 70 supplies the oil into the case 20. The oil supply device 70 comprises an oil pump 74 and an oil cooler 76. The oil cooler 76 comprises an inner passage 76a through which the oil flows. The inner passage 76a includes connection ports 76a-1, 76a-2 at its opposing ends. The oil cooler 76 cools the oil flowing through the inner passage 76a by heat exchange. The oil pump 74 and the oil cooler 76 are located in the upper portion of the case 20.

As illustrated in FIG. 4, the oil supply device 70 includes a first oil passage 71 and a second oil passage 72 that are located in the upper portion of the case 20. Further, as illustrated in FIG. 3, the oil supply device 70 includes an oil discharge passage 75 connected to a lower portion of the case 20.

As illustrated in FIG. 3, the upstream end of the oil discharge passage 75 is connected to the oil discharge port 24 defined in the bottom surface of the case 20. The downstream end of the oil discharge passage 75 is connected to an inlet of the oil pump 74. The oil pump 74 suctions the oil in the bottom portion of the case 20 through the oil discharge passage 75.

As illustrated in FIG. 4, the first oil passage 71 and the second oil passage 72 are connected to outlets of the oil pump 74. The oil pump 74 pumps out the oil suctioned through the oil discharge passage 75 to the first oil passage 71 and the second oil passage 72.

The first oil passage 71 connects the oil pump 74, the gear chamber oil supply port 21, and the connection port 76a-1 of the oil cooler 76 to each other. The first oil passage 71 comprises a pump passage 71a, a gear chamber passage 71b, and an oil cooler passage 71c. The upstream end of the pump passage 71a is connected to one of the outlets of the oil pump 74. The pump passage 71a comprises a valve 77. The valve 77 opens and closes the pump passage 71a. The downstream end of the pump passage 71a is connected to the upstream end of the gear chamber passage 71b and the upstream end of the oil cooler passage 71c. The downstream end of the gear chamber passage 71b is connected to the gear chamber oil supply port 21. The downstream end of the oil cooler passage 71c is connected to the connection port 76a-1.

The second oil passage 72 connects the oil pump 74, the motor chamber oil supply ports 22, 23, and the connection port 76a-2 of the oil cooler 76 to each other. The second oil passage 72 comprises a pump passage 72a and a motor chamber passage 72b. The upstream end of the pump passage 72a is connected to the other of the outlets of the oil pump 74. The pump passage 72a comprises a valve 78. The valve 78 opens and closes the pump passage 72a. The downstream end of the pump passage 72a is connected to the upstream end of the motor chamber passage 72b and the connection port 76a-2 of the oil cooler 76. A downstream portion of the motor chamber passage 72b branches off to two passages. The downstream end of one passage branched off from the motor chamber passage 72b is connected to the motor chamber oil supply port 22. The downstream end of the other passage branched off from the motor chamber passage 72b is connected to the motor chamber oil supply port 23. The oil supply device 70 comprises a controller (not illustrated), and the controller controls the oil pump 74 and the valves 77, 78.

The oil supply device 70 supplies the oil into the case 20 while the motor 60 is in operation. The motor 60 and the gears are lubricated and cooled by the oil suppled into the case 20. Further, the oil supply device 70 can selectively operate in a first operation mode where the oil cooled by the oil cooler 76 is supplied to the motor chamber 60a or in a second operation mode where the oil that is not cooled by the oil cooler 76 is suppled to the motor chamber 60a. The oil supply device 70 detects the temperature of the motor 60 by a temperature sensor or the like and operates in the first operation mode or the second operation mode depending on the detected temperature.

When the temperature of the motor 60 is higher than a reference value, the oil supply device 70 operates in the first operation mode. In the first operation mode, the oil supply device 70 opens the valve 77, closes the valve 78, and actuates the oil pump 74. Thus, the oil pump 74 pumps out the oil to the pump passage 71a. The oil in the pump passage 71a divergently flows into the gear chamber passage 71b and the oil cooler passage 71c.

The oil in the gear chamber passage 71b is ejected through the gear chamber oil supply port 21 toward the gears in the gear chamber 30a. The gears in the gear chamber 30a are thereby lubricated.

The oil in the oil cooler passage 71c flows through the connection port 76a-1 into the inner passage 76a. The oil flowing through the inner passage 76a is cooled by the oil cooler 76. The oil in the inner passage 76a flows through the connection port 76a-2 into the motor chamber passage 72b. The oil in the motor chamber passage 72b is supplied through the motor chamber oil supply ports 22, 23 into motor chamber 60a. The oil supplied through the motor chamber oil supply port 22 into the motor chamber 60a flows through the cooling passage 62a in the stator 62. The stator 62 is cooled by the oil flowing through the cooling passage 62a. After flowing through the cooling passage 62a, the oil is ejected into the motor chamber 60a. The oil is also ejected through the motor chamber oil supply port 23 toward the stator 62. Thereby, the stator 62 is cooled. Further, the motor 60 is lubricated by the oil ejected into the motor chamber 60a.

As described above, in the first operation mode for high-temperature motor 60, the oil cooled by the oil cooler 76 is supplied into the motor chamber 60a. The oil cooler 76 can efficiently cool the oil when the oil flows through the inner passage 76a from the connection port 76a-1 to the connection port 76a-2. Thus, in the first operation mode, sufficiently low-temperature oil is supplied into the motor chamber 60a. Therefore, the motor 60 can be efficiently cooled.

When the temperature of the motor 60 is lower than the reference value, the oil supply device 70 operates in the second operation mode. In the second operation mode, the oil supply device 70 closes the valve 77, opens the valve 78, and actuates the oil pump 74. Thus, the oil pump 74 pumps out the oil to the pump passage 72a. The oil in the pump passage 72a flows divergently into the motor chamber passage 72b and the connection port 76-2.

The oil in the motor chamber passage 72b is supplied through the motor chamber oil supply ports 22, 23 into the motor chamber 60a. The stator 62 is cooled by the oil flowing from the motor chamber oil supply port 22 into the cooling passage 62a in the stator 62. The oil is also ejected through the motor chamber oil supply port 23 toward the stator 62. Thereby, the stator 62 is cooled. Further, the motor 60 is lubricated by the oil ejected into the motor chamber 60a.

The oil flowing through the pump passage 72a toward the connection port 76a-2 flows into the inner passage 76a through the connection port 76a-2. The oil flowing through the inner passage 76a is cooled by the oil cooler 76. The oil in the inner passage 76a flows out from the connection port 76a-1, flows through the oil cooler passage 71c, and then flows into the gear chamber passage 71b. The oil in the gear chamber passage 71b is ejected through the gear chamber oil supply port 21 into the gear chamber 30a. The gears in the gear chamber 30a are thereby lubricated.

As described above, in the second operation mode for the low-temperature motor 60, the oil that has not flowed through the oil cooler 76 yet (i.e., the oil that is not cooled by the oil cooler 76) is supplied into the motor chamber 60a. Since the temperature of the oil supplied into the motor chamber 60a is relatively high, the viscosity of this oil is low. Thus, losses due to the viscosity of oil are less likely to occur in the motor 60, and the motor 60 can operate efficiently. As above, when the temperature of the motor 60 is sufficiently low, the operational efficiency of the motor 60 is improved by supplying relatively high-temperature oil into the motor chamber 60a. Although the oil cooled by the oil cooler 76 is supplied into the gear chamber 30a in the second operation mode, supplying the highly viscous oil into the gear chamber 30a does not cause large losses because the gears are less affected by the viscosity of oil than the motor 60. Further, the cooling performance of the oil cooler 76 is lower when the oil flows through the inner passage 76a from the connection port 76a-2 to the connection port 76a-1 than when the oil flows through the inner passage 76a in the opposite direction. Therefore, in the second operation mode, the cooling performance of the oil cooler 76 is lower and thus the viscosity of oil supplied into the gear chamber 30a is not that high. This further reduces losses that could be caused in the gear chamber 30a in the second operation mode. Thus, in the second operation mode, the motor unit 16 can operate efficiently.

As described above, in the motor unit 16, the flowing direction of oil in the inner passage 76a of the oil cooler 76 in the first operation mode is opposite to the flowing direction of oil therein in the second operation mode. That is, the motor unit 16 permits the oil to flow bidirectionally in the inner passage 76a of the oil cooler 76. This configuration does not require a flow passage to bypass the oil cooler 76, allowing for a reduction in the size of the motor unit 16. For example, a bypass passage 100 has to be provided as illustrated in FIG. 5 in order to supply the oil from the motor chamber passage 72b to the gear chamber oil supply port 21 in the second operation mode by bypassing the oil cooler 76. In this case, the bypass passage 100 has to be installed to pass over or under each of the other passages, which leads to an increase in the size of the motor unit. In contrast, the motor unit 16 according to this embodiment does not require such a bypass passage, allowing for a reduction in the size of the motor unit 16.

As illustrated in FIG. 4, the motor chamber oil supply port 23 and the gear chamber oil supply port 21 are spaced from each other in the vehicle width direction. The oil cooler 76 has a shape elongated in the vehicle width direction. The connection port 76a-1 and the connection port 76a-2 of the inner passage 76a of the oil cooler 76 are spaced from each other in the vehicle width direction. The connection port 76a-1 and the connection port 76a-2 are arranged such that the connection port 76a-1 is positioned closer to the gear chamber oil supply port 21 than the connection port 76a-2 is. The connection port 76a-1 and the connection port 76a-2 are located between the motor chamber oil supply port 23 and the gear chamber oil supply port 21 in the vehicle width direction. This configuration allows for a reduction in the length of flow passage connecting the connection port 76a-1 to the gear chamber oil supply port 21 and the length of flow passage connecting the connection port 76a-2 to the motor chamber oil supply port 23, which allows for a further reduction in the size of the motor unit 16.

What is claimed is:

1. A motor unit, comprising:
a case comprising a motor chamber and a gear chamber;
a motor positioned in the motor chamber;
a gear positioned in the gear chamber and engaged with a rotation shaft of the motor; and
an oil supply device configured to supply oil to the motor chamber and the gear chamber, wherein the oil supply device comprises:
an oil pump;
an oil cooler;
a first oil passage comprising a first valve, wherein the first oil passage is configured such that the oil supplied from the oil pump flows through the first oil passage when the first valve is open, and wherein the first oil passage connects the oil pump, an oil supply port of the gear chamber, and a first end of an inner passage of the oil cooler; and
a second passage comprising a second valve, wherein the second passage is configured such that the oil supplied from the oil pump flows through the second oil passage when the second valve is open, and wherein the second oil passage connects the oil pump, an oil supply port of the motor chamber, and a second end of the inner passage.

2. The motor unit of claim 1, wherein cooling performance of the oil cooler is higher when the oil flows through the inner passage from the first end to the second end than when the oil flows through the inner passage from the second end to the first end.

3. The motor unit of claim 1, wherein
the motor unit is mounted on a vehicle;
the oil supply port of the motor chamber and the oil supply port of the gear chamber are spaced from each other in a vehicle width direction,
the oil cooler comprises an elongated shape in the vehicle width direction; and
the first end and the second end are located between the oil supply port of the motor chamber and the oil supply port of the gear chamber in the vehicle width direction such that the first end is positioned closer to the oil supply port of the gear chamber than the second end is in the vehicle width direction.
